(19) United States
(12) Patent Application Publication
(10) Pub. No.: US 2025/0118900 A1
(43) Pub. Date: Apr. 10, 2025

(54) CIRCULARLY POLARIZED ANTENNA AND ELECTRONIC DEVICE

(71) Applicant: GUANGDONG COROS SPORTS TECHNOLOGY CO., LTD, Dongguan (CN)

(72) Inventor: Xianwei SHI, Dongguan (CN)

(21) Appl. No.: 18/983,551

(22) Filed: Dec. 17, 2024

Related U.S. Application Data
(63) Continuation of application No. PCT/CN2022/136869, filed on Dec. 6, 2022.

(51) Int. Cl. H01Q 9/04; H01Q 1/27; H01Q 7/00

(52) U.S. Cl. CPC H01Q 9/0492; H01Q 7/00; H01Q 1/273

(57) ABSTRACT

A circularly polarized antenna includes a main board, a radiator, a feed structure, and a perturbation structure. The radiator is in a ring shape. The feed structure is arranged between the main board and the radiator. The main board is electrically connected to the radiator through the feed structure. The perturbation structure is arranged between the main board and the radiator and configured to disturb a resonant electromagnetic field generated by the radiator.

### CROSS-REFERENCE TO RELATED APPLICATION

The present application is a continuation of International Application No. PCT/CN2022/136869, filed Dec. 6, 2022, the entire content of which is incorporated herein by reference.

### TECHNICAL FIELD

The present disclosure generally relates to the antenna apparatus technology field and, more particularly, to a circularly polarized antenna and an electronic device.

### BACKGROUND

Wearable devices such as wristbands and watches often feature satellite positioning functions. Generally, an antenna is provided to receive a satellite positioning signal. Taking the Global Positioning System (GPS) for implementing the satellite positioning function as an example, a GPS satellite signal is transmitted to the ground as a circularly polarized electromagnetic wave. If a GPS receiving antenna is linearly polarized, there will be an inherent 3 dB polarization mismatch loss, and reception signal quality is reduced. If the GPS antenna is designed as a circularly polarized antenna, the polarization mismatch loss can be greatly reduced, and the positioning function of the device is ensured.

In related art, a circularly polarized antenna includes a radiator, a main board, a feed structure, and at least one ground terminal. The feed structure is connected between the radiator and the main board. One end of the ground terminal is connected to the radiator, and the other end is connected to the main board through an inductor or capacitor. This structure requires that inductor or capacitor be added between the radiator and the main board. On the one hand, such configuration has increased complexity and manufacturing cost. On the other hand, due to the parasitic resistance of the integrated element, a part of the radiation efficiency of the antenna is lost. Thus, high overall efficiency is difficult to achieve.

### SUMMARY

In accordance with the disclosure, there is provided a circularly polarized antenna including a main board, a radiator, a feed structure, and a perturbation structure. The radiator is in a ring shape. The feed structure is arranged between the main board and the radiator. The main board is electrically connected to the radiator through the feed structure. The perturbation structure is arranged between the main board and the radiator and configured to disturb a resonant electromagnetic field generated by the radiator.

In accordance with the disclosure, there is provided an electronic device, including a shell and a circularly polarized antenna. The circularly polarized antenna includes a main board, a radiator, a feed structure, and a perturbation structure. The radiator is in a ring shape. The feed structure is arranged between the main board and the radiator. The main board is electrically connected to the radiator through the feed structure. The perturbation structure is arranged between the main board and the radiator and configured to disturb a resonant electromagnetic field generated by the radiator.

### BRIEF DESCRIPTION OF THE DRAWINGS

FIG. 1 is a schematic structural diagram of a circularly polarized antenna according to some embodiments of the present disclosure.

FIG. 2 is a schematic diagram showing a first current and a first current strong region at a radiator according to some embodiments of the present disclosure.

FIG. 3 is a schematic diagram showing a second current and a second current strong region at a radiator according to some embodiments of the present disclosure.

FIG. 4 is a schematic diagram showing an overlapped region at a radiator according to some embodiments of the present disclosure.

FIG. 5 is a schematic diagram showing an overlapped region, a first current strong region, a second current strong region, a perturbation structure, and a feed structure at a radiator according to some embodiments of the present disclosure.

FIG. 6 is a schematic diagram showing relationship curves between frequencies of a first linearly polarized wave and a second linearly polarized wave and contribution degrees of the linearly polarized waves to a total radiation field according to some embodiments of the present disclosure.

FIG. 7 is a schematic diagram showing a perturbation structure and a feed structure for realizing right-handed circular polarization at a radiator when the perturbation structure is in a block shape according to some embodiments of the present disclosure.

FIG. 8 is a schematic structural diagram of a radiator when a perturbation structure includes two members according to some embodiments of the present disclosure.

FIG. 9 is a schematic diagram showing a perturbation structure and a feed structure for realizing left-handed circular polarization at a radiator when the perturbation structure includes two members according to some embodiments of the present disclosure.

FIG. 10 is a schematic diagram of a perturbation structure and a feed structure for realizing right-handed circular polarization at a radiator when the perturbation structure is in a block shape according to some embodiments of the present disclosure.

FIG. 11 is a schematic structural diagram showing a perturbation structure in a block shape arranged at a main board according to some embodiments of the present disclosure.

FIG. 12 is a schematic structural diagram showing a perturbation structure having two members arranged at a main board according to some embodiments of the present disclosure

FIG. 13 is a schematic structural diagram showing a perturbation structure in a block shape without being connected to a main board and a radiator according to some embodiments of the present disclosure.

FIG. 14 is a schematic structural diagram of a perturbation structure having a concave structure according to some embodiments of the present disclosure.

FIG. 15 is a schematic diagram of a perturbation structure and a feed structure for realizing left-handed circular polarization at a radiator when the perturbation structure has a concave structure according to some embodiments of the present disclosure.

FIG. 16 is a schematic diagram of a perturbation structure and a feed structure for realizing right-handed circular polarization at a radiator when the perturbation structure has a concave structure according to some embodiments of the present disclosure.

FIG. 17 is a schematic structural diagram showing a perturbation structure at a radiator having a concave structure and two members according to some embodiments of the present disclosure.

FIG. 18 is a schematic diagram of a perturbation structure and a feed structure for realizing right-handed circular polarization when the perturbation structure at a radiator has a concave structure and two members according to some embodiments of the present disclosure.

FIG. 19 is a schematic diagram of a perturbation structure and a feed structure for realizing left-handed circular polarization when the perturbation structure at a radiator has a concave structure and two members according to some embodiments of the present disclosure.

### REFERENCE NUMERALS

1 Main board 2 Radiator 3 Feed structure 4 Perturbation structure 5 Glass dial

### DETAILED DESCRIPTION OF THE EMBODIMENTS

Embodiments of the present disclosure are described in connection with the accompanying drawings. The described embodiments are merely some embodiments of the present disclosure, not all the embodiments. Based on the embodiments of the present disclosure, all other embodiments obtained by those skilled in the art without creative efforts are within the scope of the present disclosure.

In the description of the disclosure, terms “connected,” “coupled,” and “fixed” should be broadly interpreted unless otherwise specified and defined. For example, the connection can be a fixed connection, a detachable connection, or an integration; a mechanical connection or an electrical connection; or a direct connection, an indirect connection through an intermedium, or an internal communication or an interaction relationship of two elements intermediaries; or communication or interaction between two components. For those skilled in the art, the meanings of the above terms in the present disclosure can be understood according to context.

In the present disclosure, a first feature being “on” or “under” a second feature can include the first feature directly contacting the second feature, or the first feature not directly contacting the second feature but the first feature contacting the second feature through another feature. Moreover, the first feature being “on,” “above,” and “over” the second feature can include the first feature being right above and diagonally above the second feature, or merely a horizontal height of the first feature being higher than a horizontal height of the second feature. The first feature being “below,” “under,” and “lower than” the second feature can include the first feature is right under and diagonally under the second feature or the horizontal height of the first feature being smaller than the horizontal height of the second feature.

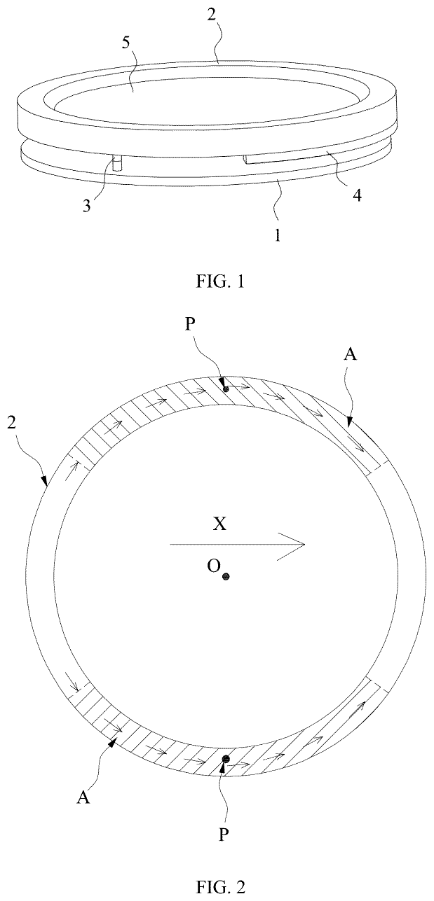

Embodiments of the present disclosure provide a circularly polarized antenna. As shown in FIGS. 1 to 13, the circularly polarized antenna includes a main board 1, a radiator 2, a feed structure 3, and a perturbation structure 4. The radiator 2 is ring-shaped. The feed structure 3 is arranged between the main board 1 and the radiator 2. The main board 1 is electrically connected to the radiator 2 through the feed structure 3. The perturbation structure 4 is arranged between the main board 1 and the radiator 2 and configured to disturb a resonant electromagnetic field between the radiator 2 and the main board 1.

The feed structure 3 can be arranged at the radiator 2 to excite a first linearly polarized wave and a second linearly polarized wave having orthogonal directions and equal amplitudes to form the resonant electromagnetic field. The perturbation structure 4 can be provided to disturb the electromagnetic field, i.e., change the resonant frequencies of the first linearly polarized wave and the second linearly polarized wave. Thus, the first linearly polarized wave and the second linearly polarized wave can have a phase difference of π/2 to realize circular polarization.

In the circularly polarized antenna of the present disclosure, the first linearly polarized wave and the second linearly polarized wave with perpendicular oscillation directions and equal amplitudes and resonant frequencies can be provided to the radiator 2 through the feed structure 3 to form the resonant electromagnetic field. The perturbation structure 4 can be configured to disturb the resonant electromagnetic field generated by the radiator 2, i.e., change the resonant frequencies of the first linearly polarized wave and the second linearly polarized wave. Thus, with the change in the frequencies of the first linearly polarized wave and the second linearly polarized wave, the phase difference between the first linearly polarized wave and the second linearly polarized wave can be approximately π/2 to realize the circular polarization. In embodiments of the present disclosure, the circularly polarized antenna has a simple structure without ground terminal, capacitor, or inductor, which reduces the complexity of the structure and the manufacturing cost and improves the radiation efficiency of the antenna.

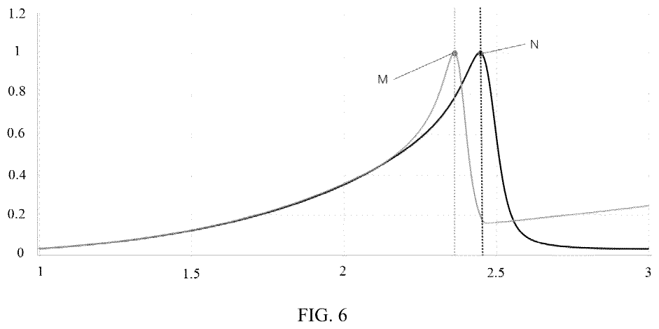

In FIG. 6, the horizontal axis represents frequency, and the vertical axis represents the contribution degree of the linearly polarized wave to the overall radiation field. Curve M represents the relationship between the frequency of the first linearly polarized wave and the contribution degree of the linearly polarized wave to the overall radiation field. The frequency value corresponding to the peak of curve M is the resonant frequency of the first linearly polarized wave. Curve N represents the relationship between the frequency and the contribution degree of the second linearly polarized wave to the overall radiation field. The frequency value corresponding to the peak of curve N is the resonant frequency of the second linearly polarized wave.

When the resonant electromagnetic field is not disturbed by the perturbation structure 4, the resonant frequency of the first linearly polarized wave can be the same as the resonant frequency of the second linearly polarized wave, and the amplitude of the first linearly polarized wave can be equal to the amplitude of the second linearly polarized wave. Thus, curve M can coincide with curve N. After the resonant electromagnetic field is disturbed by the perturbation structure 4, the resonant frequency of the first linearly polarized wave can be different from the resonant frequency of the second linearly polarized wave. As shown in FIG. 6, the contribution degree of the first linearly polarized wave and the contribution degree of the second linearly polarized wave to the overall radiation field reach peak values under different frequencies, respectively. Thus, the phase difference between the first linearly polarized wave and the second linearly polarized wave can reach about π/2, realizing circular polarization.

In some embodiments, the main board 1 can be a printed circuit board (PCB) with circuits and other devices. For the structure of the main board 1 and types and quantities of devices, reference can be made to relevant technology.

In some embodiments, the radiator 2 can be a metal ring. The perimeter of the radiator 2 can be a wavelength of the operation frequency of the circularly polarized antenna. The material of the radiator 2 can be copper, aluminum, or other materials with good conductivity.

In some embodiments, the ring structure of the radiator 2 can be a circular ring, a triangular ring, a rectangular ring, a diamond-shaped ring, a rounded rectangular ring, or another polygonal ring.

In some embodiments, the inner sidewall and the outer sidewall of the radiator 2 are circular and coaxially arranged. Thus, the radiator 2 can have a uniform width and be easily processed. The end surface on the side of the radiator 2 facing the main board 1 and the end surface on the side of the radiator 2 away from the main board 1 are parallel to the main board 1 and can be easy to process. The axis of the radiator 2 can be perpendicular to the main board 1.

In some embodiments, the plane of the main board 1 can be parallel to the plane of the radiator 2 with a distance therebetween.

In some embodiments, the distance between the main board 1 and the radiator 2 is L, and

$$L ∈ ( 0 , \frac{1}{10} M ) .$$

M represents the perimeter of the radiator 2. When the distance between the main board 1 and the radiator 2 is small, the thicknesses of the circularly polarized antenna and the electronic device can be reduced, and the space occupied by the circularly polarized antenna can be reduced to improve practicality.

In some embodiments,

$$L ∈ ( 0 , \frac{1}{20} M ) .$$

For example, L can be set to

$$L = \frac{1}{25} M , L = \frac{1}{30} M ,$$

$$L = \frac{1}{35} M , or L = \frac{1}{40} M .$$

In some other embodiments, the value of L can be adaptively adjusted as needed.

In some embodiments, the perturbation structure 4 can be electrically connected to the radiator 2. Thus, the radiator 2 can be processed conveniently to simplify the manufacturing process of the circularly polarized antenna.

In some embodiments, the perturbation structure 4 can be electrically connected to the main board 1. For example, the projection of the perturbation structure 4 on the plane of the radiator 2 can at least partially coincide with the radiator 2. In some embodiments, the perturbation structure 4 can be directly arranged at the radiator 2 or the main board 1. In some embodiments, as shown in FIG. 13, the perturbation structure 4 is not connected to the radiator 2 and the main board 1. The perturbation structure 4 can be fixedly arranged between the radiator 2 and the main board 1 through other external insulation structure and can be electrically connected to the radiator 2 or the main board 1 through wires or other conductors. The external insulation structure should not disturb the electromagnetic field between the radiator 2 and the main board 1.

In some embodiments, the perturbation structure 4 can be block-shaped and arranged between the main board 1 and the radiator 2.

In some embodiments, the perturbation structure 4 can protrude from the main board 1 or the radiator 2.

For example, the perturbation structure 4 can be welded to the main board 1 or the radiator 2 or integrally formed with the radiator 2.

In some embodiments, the perturbation structure 4 can be arranged at one of the main board 1 or the radiator 2 and insulated from the other one of the main board 1 and the radiator 2. The vertical distance between the radiator 2 and the main board 1 can be set as a first height. The perturbation structure 4 can be arranged at one of the main board 1 and the radiator 2, and the height between the perturbation structure 4 and the other one of the main board 1 and the radiator 2 can be set as a second height. The first height can be greater or smaller than the second height. The perturbation structure 4 can be arranged at an interval with the other one of the main board 1 and the radiator 2 to realize the insulation between the perturbation structure 4 and the other one of the main board 1 and the radiator 2. When the perturbation structure 4 is connected to the radiator 2, the perturbation structure 4 can extend onto the main board 1 and contact the insulation part of the main board 1 to realize the insulation.

In some embodiments, the extension direction of the perturbation structure 4 can be arc-shaped. The perturbation structure 4 can be coaxial with the radiator 2. Thus, the position of the perturbation structure 4 can be easily determined.

In some embodiments, the width of the perturbation structure 4 can be the same as or different from the width of the radiator 2. For example, the width of the perturbation structure 4 can be the same as the width of the radiator 2 to facilitate manufacturing.

The radiator 2 can radiate the first linearly polarized wave and the second linearly polarized wave. The oscillation directions of the first linearly polarized wave and the second linearly polarized wave are perpendicular to each other, and the amplitudes and the resonant frequencies of the first linearly polarized wave and the second linearly polarized wave can be the same. The first linearly polarized wave and the second linearly polarized wave can excite a first current and a second current with directions perpendicular to each other, respectively, at the radiator 2.

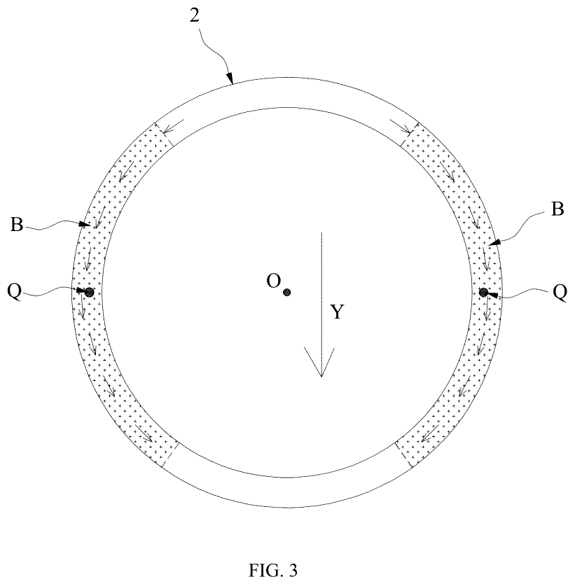

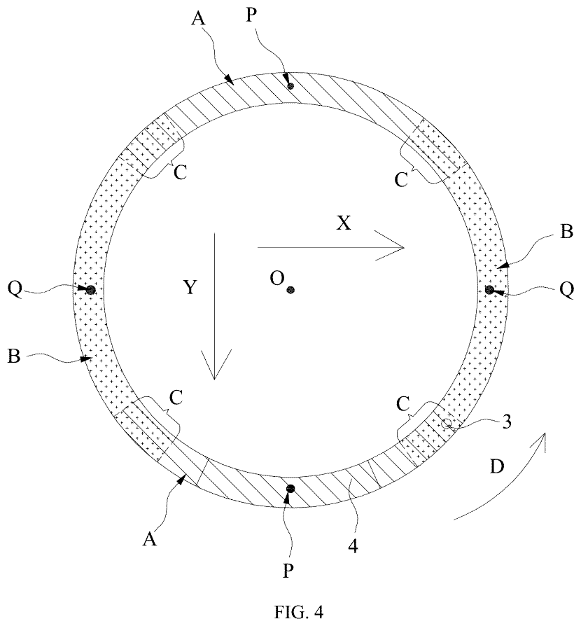

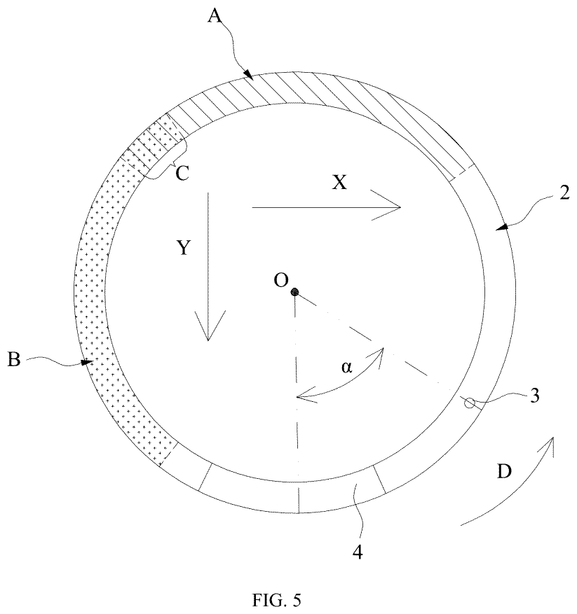

The first current can form a first current strong region A at the radiator 2. The first current strong region A can be a region of the radiator 2 having the first current greater than 0. The first current strong region A can be an arc-shaped region. The axis of the first current strong region A and the axis of the radiator 2 can be colinear. Two first current strong regions A can be provided and essentially symmetrical about the center of the radiator 2. The center position of each first current strong region A can be the position where the current value of the first current is the largest (i.e., first antinode). The central angle corresponding to each first current strong region A can be smaller than 180°. In the examples shown in FIG. 2, FIG. 4, and FIG. 5, the direction of the first current excited by the first linearly polarized wave at the radiator 2 is direction X, the two first current strong regions A are arranged in direction X on an upper side and a lower side of the radiator 2, and the two first current strong regions A are located at an upper region and a lower region of the radiator 2, respectively. In some embodiments, the direction of the first current excited by the first linearly polarized wave at the radiator 2 can be direction Y, the two first current strong regions A can be arranged along direction Y on a right side and a left side of the radiator 2, and the two first current strong regions A can be located at a left region and a right region of the radiator 2, respectively.

In FIG. 2, point O is the center of the radiator 2, point P is the first antinode, and the arrows in the ring of the radiator 2 distributed along the circumference point to the direction of the first current. The figure only shows the direction of the first current from left to right. The direction of the first current can be from right to left. The density of the arrows can represent the magnitude of the first current. The arrows can be relatively dense in the first current strong region A, and the arrows can be relatively sparse outside the first current strong region A. The number of arrows only represents the relative magnitude of the first current and does not represent the value of the first current.

The second current can form a second current strong region B at the radiator 2. The second current strong region B can be a region where the second current is greater than 0. The second current strong region B can be an arc-shaped area. The axis of the second current strong region B can be colinear with the axis of the radiator 2. Two second current strong regions B can be provided and essentially symmetrical about the center of the radiator 2. The center position of each second current strong region B can be the position where the current value of the second current is the largest (i.e., second antinode). The central angle corresponding to each second current strong region B can be smaller than 180°. In the examples shown in FIG. 3, FIG. 4, and FIG. 5, the direction of the second current excited by the second linearly polarized wave at the radiator 2 is direction Y, the two second current strong regions B are arranged in direction Y on a left side and a right side of the radiator 2, and the two second current strong regions B are located at a left region and a right region of the radiator 2, respectively. In some embodiments, the direction of the second current excited by the second linearly polarized wave at the radiator 2 can also be direction X, the two second current strong regions B can be arranged along direction X at the upper side and the lower side of the radiator 2, and the two second current strong regions B can be located at the upper region and the lower region of the radiator 2, respectively. Direction X and direction Y can be perpendicular to the axis of the radiator 2. Direction X can be also perpendicular to direction Y. The connection line between the two first antinodes can be perpendicular to the connection line between the two second antinodes.

In FIG. 3, point O is the center of the radiator 2, point Q is the second antinode, and the arrows in the ring of the radiator 2 distributed along the circumference point to the direction of the second current. The figure only shows the direction of the second current from top to bottom. The direction of the second current can be from bottom to top. The density of the arrows can represent the magnitude of the current. The arrows can be relatively dense in the second current strong region B and the arrows can be relatively sparse outside the second current strong region B. The number of the arrows only represents the relative magnitude of the second current and does not represent the value of the second current.

In some embodiments, the projection of the perturbation structure 4 at the radiator 2 can at least partially cover the first antinode. For example, the projection of the centerline of the perturbation structure 4 at the radiator 2 can coincide with the first antinode. The centerline of the perturbation structure 4 can extend along a radial direction of the radiator 2.

In some embodiments, the projection of the centerline of the perturbation structure 4 at the radiator 2 and the connection place of the feed structure 3 and the radiator 2 can form an arc α in a first surrounding direction, where α∈(0°, 90°)∪(180°, 270°) or α∈ (120°, 180°)∪(300°, 360°). The first surrounding direction can be a counter-clockwise surrounding direction when facing the top of the radiator 2. The surface of the radiator 2 facing the main board 1 can be the bottom surface of the radiator 2. The perturbation structure 4 and the feed structure 3 can be arranged under the radiator 2. In FIG. 5, direction D is the first surrounding direction.

In some other embodiments, α∈(0°, 60°)∪(180°, 240°) or α∈(120°, 180°)∪(300°, 360°).

In some embodiments, the projection of the centerline of the perturbation structure 4 at the radiator 2 and the connection place of the feed structure 3 and the radiator 2 can form an arc β in a second surrounding direction, where β∈(0°, 90°)∪(180°, 270°) or β∈(90°, 180°)∪(270°, 360°). The second surrounding direction can be a clockwise surrounding direction when facing the top of the radiator.

In some other embodiments, β∈(0°, 60°)∪(180°, 240°) or β∈(120°, 180°)∪(300°, 360°).

FIGS. 5, 7, 9, 10, 15, 16, 18, and 19 are top views of the radiator 2. However, for illustration, the feed structure 3 and the perturbation structure 4 are depicted in solid lines.

In some embodiments, when α∈(0°, 60°)∪(210°, 270°) or β∈(0°, 60°)∪(210°, 270°), the antenna can realize right-handed circular polarization. When α∈(90°, 180°)∪(270°, 360°) or β∈(90°, 180°)∪(270°, 360°), the antenna can realize left-handed circular polarization.

In some embodiments, when α∈(30°, 60°)∪(210°, 240°) or β∈(30°,60°)∪(210°, 240°), the antenna can realize right-handed circular polarization. When α∈(120°, 150°)∪(300°, 330°) or β∈(120°, 150°)∪(300°, 330°), the antenna can realize left-handed circular polarization.

In fact, four overlapped regions C can be formed between the first current strong regions A and the second current strong regions B with the central angles corresponding to the two second current strong regions B and centered at the two second antinodes being about 120° and the central angles corresponding to the two first current strong regions A and centered at the two first antinodes being about 120°. As shown in FIG. 4, the arc ranges corresponding to the four overlapped regions C can be approximately (30°, 60°), (210°, 240°), (120°, 150°), and (300°, 330°) in the first surrounding direction. The feed structure 3 can be arranged in the overlapped regions C to realize circular polarization.

In some embodiments, the arc ranges corresponding to the four overlapped regions C in the second surrounding direction can approximately be (30°, 60°), (210°, 240°), (120°, 150°), and (300°, 330°). The feed structure 3 can be arranged in the overlapped regions C to realize circular polarization.

To facilitate understanding, taking the center point of the perturbation structure 4 located at the first antinode of the first current as an example, how a circularly polarized wave is generated is described.

For the first linearly polarized wave, the center of the perturbation structure 4 can be located at the first antinode. The perturbation structure 4 can be block-shaped and arranged between the main board 1 and the radiator 2, either at the radiator 2 or the main board 1 to increase the resonant frequency of the first linearly polarized wave.

For the second linearly polarized wave, the center of the perturbation structure 4 can be located at the second node. The perturbation structure 4 can be block-shaped and protrude from the radiator 2 or the main board 1 to reduce the resonant frequency of the second linearly polarized wave. The second node can be the position where the second current is smallest. The first antinode can coincide with the second node.

That is, the perturbation structure 4 can change the resonant frequencies of the first linearly polarized wave and the second linearly polarized wave to cause the phase difference between the first linearly polarized wave and the second linearly polarized wave to be π/2. When the length of the perturbation structure 4 in the circumferential direction of the radiator 2 is small, the width and height of the perturbation structure 4 can be increased adaptively. When the width of the perturbation structure 4 is small, the length along the circumferential direction of the radiator 2 and the height of the perturbation structure 4 can be increased adaptively. When the height of the perturbation structure 4 is small, the length along the circumferential direction of the radiator 2 and the width of the perturbation structure 4 can be increased adaptively.

In addition, when the perturbation structure 4 is arranged at the main board 1, the surface of the perturbation structure 4 facing the radiator 2 can be parallel to the radiator 2. When the perturbation structure 4 is arranged at the radiator 2, the surface of the perturbation structure 4 facing the main board 1 can be parallel to the main board 1. This avoids the situation of not easily arranging other structures of the circularly polarized antenna or the electronic device caused by one end of the perturbation structure 4 being higher. Thus, the manufacturing can be facilitated.

In some embodiments, the feed structure 3 can be electrically connected to the radiator 2 but not connected to the perturbation structure 4.

In some embodiments, the central angle corresponding to the perturbation structure 4 can be less than 180°, which avoids excessive length of the perturbation structure 4 that affects the disturbance of the electromagnetic field.

In some embodiments, the central angle corresponding to the perturbation structure 4 can be less than 120°. In some embodiments, the projection of the centerline of the perturbation structure 4 on the plane of the radiator 2 can at least partially overlap with the first antinodes or the second antinodes.

In some embodiments, the perturbation structure 4 can include two members arranged at an interval along the circumference of the radiator 2, and the central angle corresponding to each member can be less than 90°. Thus, the length of each perturbation structure 4 can be shortened to easily avoid other structures of the circularly polarized antenna or the electronic device and simplify the difficulty in the assembly of the electronic device.

In some embodiments, the perturbation structure 4 can include two members arranged at an interval. The two members can be symmetrically arranged on two sides of the connection line of the two first antinodes or the connection line of the two second antinodes. When α∈(0°, 90°)∪(180°, 270°), the antenna can realize right-handed circular polarization. When α∈(90°, 180°)∪(270°, 360°), the antenna can realize left-handed circular polarization.

In some embodiments, the perturbation structure 4 can be arranged at the main board 1 or in the gap between the main board 1 and the radiator 2. The projections of the two members on the plane of the radiator 2 can be symmetrical about the connection line of the two first antinodes. The arcs corresponding to the two members can be the same or different.

In some embodiments, as shown in FIGS. 4 and 5, the perturbation structure 4 is arranged at the radiator 2. The projection of the perturbation structure 4 on the plane of the radiator 2 can be symmetrical about the connection line of the two first antinodes. Moreover, the connection line between the first antinodes that overlap with the projection of the centerline of the perturbation structure 4 at the radiator 2 and the connection place between the feed structure 3 and the radiator 2 can form an arc α∈(0°, 90°) in the first surrounding direction. Thus, the antenna corresponding to the feed structure 3 can realize the right-handed polarization.

For illustration purposes, FIG. 5 only shows one first current strong region A and one second current strong region B.

In some embodiments, as shown in FIG. 7, the perturbation structure 4 is arranged at the radiator 2. The projection of the perturbation structure 4 at the plane of the radiator 2 is symmetrical about the connection line of the two first antinodes, and α∈(270°, 360°). The antenna corresponding to the feed structure 3 can realize the left-handed circular polarization.

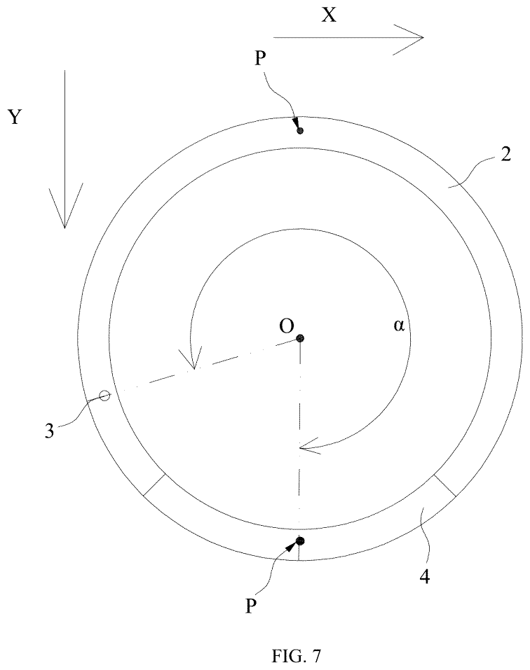

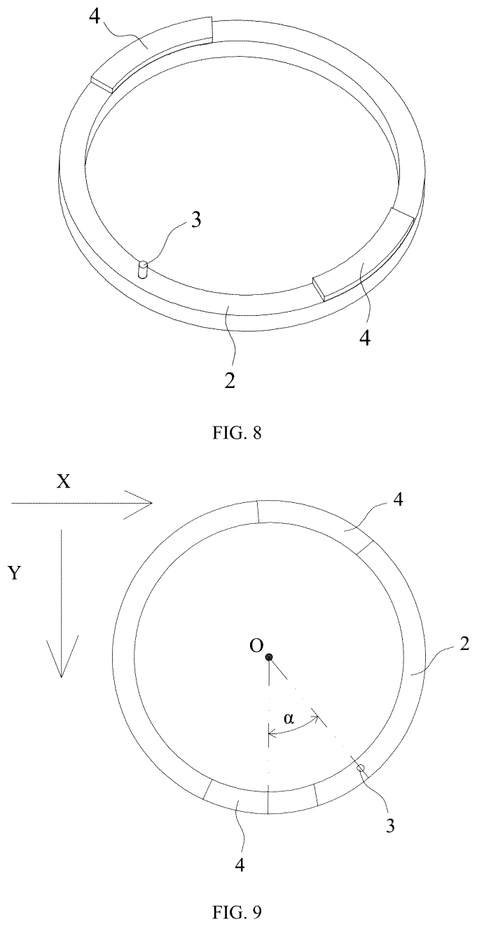

In some embodiments, as shown in FIG. 8 and FIG. 9, the perturbation structure 4 includes two members arranged at an interval at the radiator 2.

In some embodiments, the two members are arranged in the upper region and the lower region of the radiator 2, respectively, and α∈(0°,90°)∪(180°, 270°). Then, the projection of each member on the plane of the radiator 2 is symmetrical about the connection line of the two first antinodes. The antenna corresponding to the feed structure 3 can realize the right-handed circular polarization.

In some embodiments, as shown in FIG. 10, the perturbation structure 4 includes two members arranged at an interval at the radiator 2.

In some embodiments, the two members are arranged in the upper region and the lower region of the radiator 2, and α∈(90°, 180°)∪(270°, 360°). Then, the projection of each member on the plane of the radiator 2 is symmetrical about the connection line of the two first antinodes. The antenna corresponding to the feed structure 3 can realize the left-handed circular polarization.

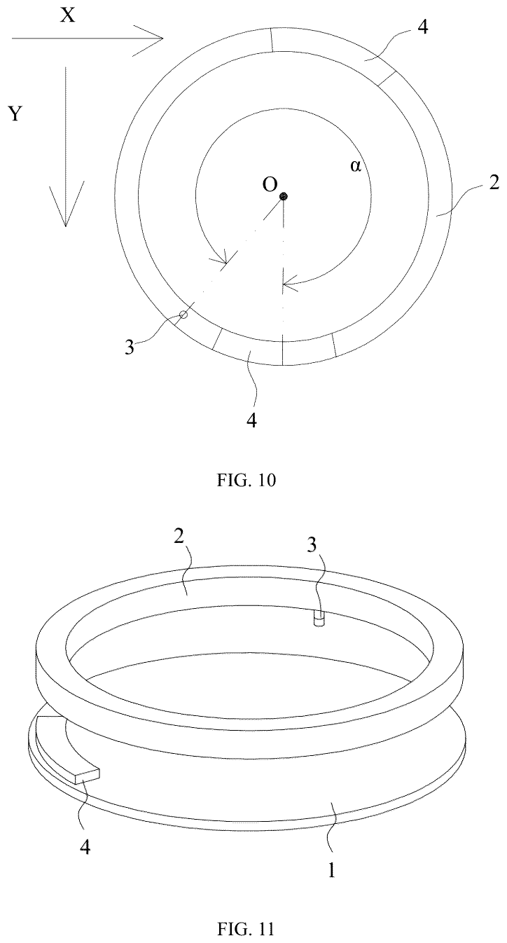

In some embodiments, as shown in FIG. 11, the perturbation structure 4 is arranged at the main board 1, and the projection of the perturbation structure 4 on the plane of the radiator 2 at least partially overlaps with the radiator 2. The projection of the centerline of the perturbation structure 4 on the plane of the radiator 2 can at least partially overlap with any one of the first antinodes.

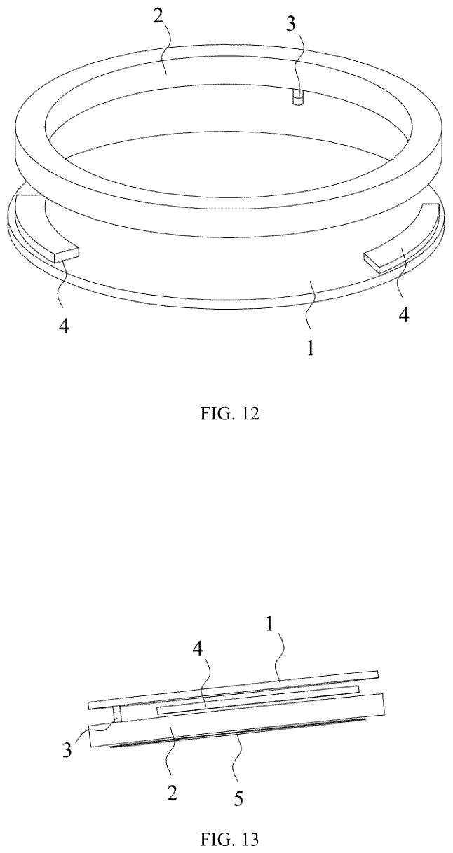

In some embodiments, as shown in FIG. 12, the perturbation structure 4 includes two members arranged at an interval on the main board 1. The projection of each member on the plane of the radiator 2 at least partially overlaps with the radiator 2.

In some embodiments, the projection of each member on the plane of the radiator 2 can be symmetrical about the connection line of the two first antinodes.

In some embodiments, as shown in FIG. 13, the perturbation structure 4 is arranged between the main board 1 and the radiator 2. The projection of the perturbation structure 4 on the plane of the radiator 2 at least partially overlaps with the radiator 2. The projection of the perturbation structure 4 on the plane of the radiator 2 is symmetrical about the connection line of the two first antinodes.

In some embodiments, the perturbation structure 4 can be a solid structure, e.g., a solid block, which can be integrally formed with the radiator 2 or welded directly to the radiator 2 or the main board 1 through an arc-shaped metal strip to facilitate manufacturing. In some embodiments, the perturbation structure 4 can be a shell. That is, the perturbation structure 4 can be hollow inside, which is beneficial to reduce the weight of the circularly polarized antenna to improve the practicality. For example, an insulation block structure can be fixed at the radiator 2, and the perturbation structure 4 can be a metal layer covering the outer side of the insulation structure.

Similarly, the radiator 2 can also be a solid structure or a hollow shell structure. When the perturbation structure 4 is a solid structure, the radiator 2 can also be a solid structure. The radiator 2 and the perturbation structure 4 can be directly welded. When the perturbation structure 4 is shell-shaped, the radiator 2 can also have the shell structure. The radiator 2 can be a metal layer covering at the outer side of the insulation ring. The insulation ring can be integrally provided with the insulation block structure. The perturbation structure 4 can be a metal layer covering the outer side of the insulation block structure.

In some embodiments, the main board 1 can include a functional module, and the feed structure 3 can be arranged between the radiator 2 and the main board 1. The first end of the feed structure 3 can be electrically connected to the radiator 2. The second end can be electrically connected to the functional module. In embodiments of the present disclosure, the functional module can be a GPS module. For the functional module, reference can be made to related technologies. In some other embodiments, the functional module can be other modules.

In some embodiments, the feed structure 3 can be welded to the main board 1. The feed structure 3 can be welded to or integrally formed with the radiator 2.

In some embodiments, the projection plane and the projection direction are set. The projection plane can be on the side of the main board 1 away from the radiator 2 and parallel to the main board 1. The projection direction can be perpendicular to the projection plane. The projection of the feed structure 3 in the projection plane along the projection direction can be outside the projection range of the perturbation structure 4 in the projection plane along the projection direction.

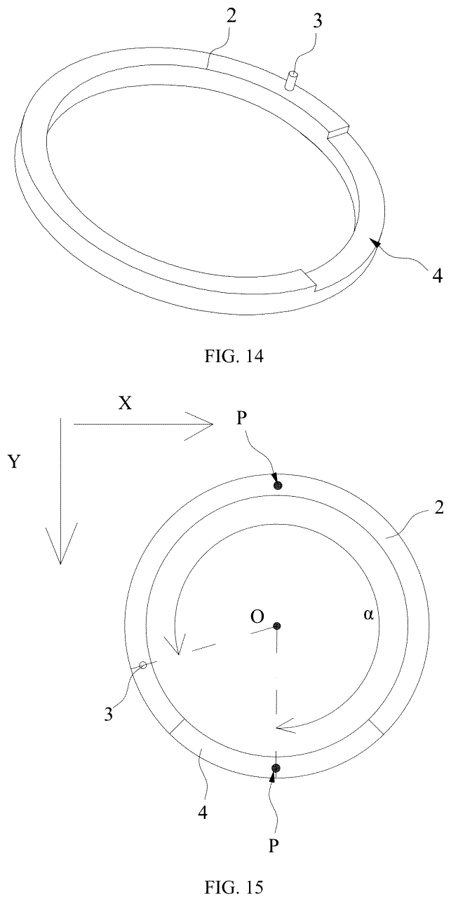

As shown in FIGS. 14 to 19, another circularly polarized antenna is provided and has a structure basically the same as the above circularly polarized antenna. Only the perturbation structure 4 has some difference in the structure. Thus, the same structures are not repeated in the following description.

In some embodiments, the perturbation structure 4 can be a concave structure and arranged at the radiator 2. The opening of the concave structure can face the main board 1. That is, the perturbation structure 4 can be a groove recessed at the radiator 2. Thus, the perturbation structure 4 can be formed through slotting to realize disturbing of the electromagnetic field between the radiator 2 and the main board 1 and reduce the weight of the radiator 2. Thus, the weight of the circularly polarized antenna and the electronic device can be reduced, and the practicality of the circularly polarized antenna and the electronic device can be improved, which is beneficial to reducing the material cost.

To facilitate understanding, by taking the center of the perturbation structure 4 being at the first antinode of the first current as an example, how the antenna realizes the circular polarization can be described.

For the first linearly polarized wave, the center of the perturbation structure 4 can be located at the first antinode. The perturbation structure 4 can be recessed at the radiator 2 to reduce the resonant frequency of the first linearly polarized wave.

For the second linearly polarized wave, the center of the perturbation structure 4 can be located at the second node, and the perturbation structure 4 can be recessed at the radiator 2 to increase the resonant frequency of the second linearly polarized wave.

That is, the perturbation structure 4 can change the resonant frequencies of the first linearly polarized wave and the second linearly polarized wave to cause the phase difference between the first linearly polarized wave and the second linearly polarized wave to be π/2. When the length of the perturbation structure 4 in the circumferential direction of the radiator 2 is small, the width and the slot depth of the perturbation structure 4 can be increased adaptively. When the width of the perturbation structure 4 is small, the length along the circumferential direction of the radiator 2 and slot depth of the perturbation structure 4 can be increased adaptively. When the slot depth of the perturbation structure 4 is small, its length in the circumferential direction of the radiator 2 and the width of the perturbation structure can be increased adaptively.

In addition, for example, the bottom surface of the groove of the perturbation structure 4 can face the main board 1 and can be parallel to the main board 1 to facilitate manufacturing.

The perturbation structure 4 can be a recessed structure. In the first circumferential direction, when α∈(0°, 90°)∪(180°, 270°), the left-handed circular polarization can be realized.

In some embodiments, α∈(0°, 60°)∪(180°, 240°).

In some other embodiments, α∈(30°, 60°)∪(210°, 240°).

When α∈(90°, 180°)∪(270°, 360°), the right-handed circular polarization can be realized.

In some embodiments, α∈(120°, 180°)∪(300°, 360°).

In some other embodiments, α∈(120°, 150°)∪(300°, 330°).

In some embodiments, as shown in FIG. 14 and FIG. 15, the perturbation structure 4 is a recessed structure arranged at the radiator 2. The perturbation structure 4 is symmetrical about the connection line of the two first antinodes, and α∈(270°, 360°), the antenna can realize the right-handed circular polarization.

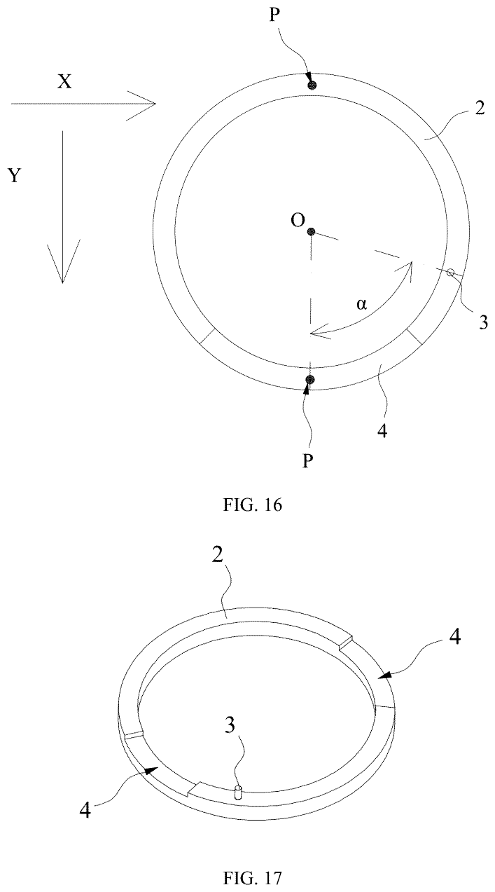

In some embodiments, as shown in FIG. 16, the perturbation structure 4 is a recessed structure arranged at the radiator 2. The perturbation structure 4 is symmetrical about the connection line of the two first antinodes, and α∈(0°, 90°). The projection of the perturbation structure 4 on the plane of the radiator 2 is symmetrical about the connection line of the two first antinodes. The antenna can realize the left-handed circular polarization.

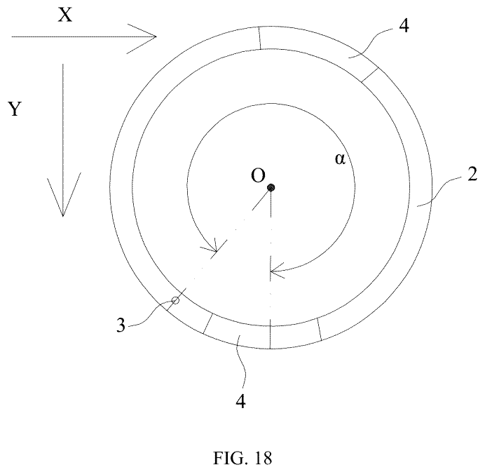

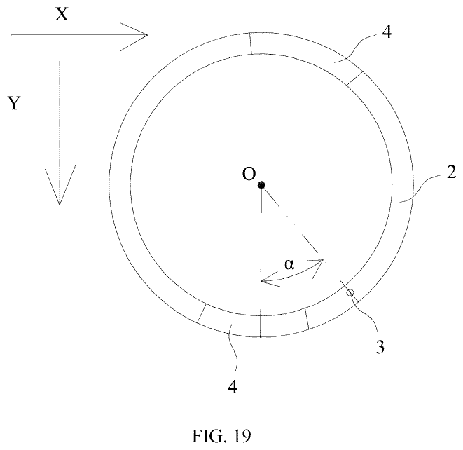

In some embodiments, as shown in FIG. 17 and FIG. 18, the perturbation structure 4 is a recessed structure arranged at the radiator 2. The perturbation structure 4 includes two members arranged at an interval. The two members can be symmetrical about the connection line of the two first antinodes, and α∈(90°, 180°)∪(270°, 360°), the antenna can realize the right-handed circular polarization.

In some embodiments, as shown in FIG. 19, the perturbation structure 4 is a recessed structure arranged at the radiator 2. The perturbation structure 4 includes two members arranged at an interval. The two members can be symmetrical about the connection line of the two first antinodes, and α∈(0°, 90°)∪(180°, 270°), the antenna can realize the left-handed circular polarization.

In some embodiments, the perturbation structure can be a recessed structure. In the second surrounding direction, when β∈(0°, 90°)∪(180°, 270°), the antenna can realize the left-handed circular polarization.

In some other embodiments, β∈(0°,60°)∪(180°, 240°).

In some embodiments, β∈(30°, 60°)∪(210°, 240°).

When β∈(90°, 180°)∪(270°, 360°), the antenna can realize the right-handed circular polarization.

In some embodiments, β∈(120°, 180°)∪(300°, 360°).

In some other embodiments, β∈(120°, 150°)∪(300°, 330°).

In some embodiments, the perturbation structure 4 can be a recessed structure and arranged at the radiator 2. The perturbation structure 4 can be symmetrical about the connection line of the two first antinodes, and β∈(270°, 360°). The antenna can realize the right-handed circular polarization.

In some embodiments, the perturbation structure 4 can be a recessed structure and arranged at the radiator 2. The perturbation structure 4 can be symmetrical about the connection line of the two first antinodes, and β∈(0°, 90°). Then, the projection of the perturbation structure 4 on the plane of the radiator 2 can be symmetrical about the connection line of the two first antinodes. The antenna can realize the left-handed circular polarization.

In some embodiments, the perturbation structure 4 can be a recessed structure and arranged at the radiator 2. The perturbation structure 4 can include two members arranged at an interval. The two members can be symmetrical about the connection line of the two antinodes, and β∈(90°, 180°)∪(270°, 360°). The antenna can realize the right-handed circular polarization.

In some embodiments, the perturbation structure 4 can be a recessed structure and arranged at the radiator 2. The perturbation structure 4 can include two members arranged at an interval. The two members can be symmetrical about the connection line of the two first antinodes, and β∈(0°, 90°)∪(180°, 270°). The antenna can realize the left-handed circular polarization.

Embodiments of the present disclosure can further provide an electronic device. For example, the electronic device can include a shell and the circularly polarized antenna above.

The circularly polarized antenna and the electronic device of embodiments of the present disclosure can have a simple structure by avoiding structures such as the ground terminal, the capacitor, or the inductor. Thus, the complexity of the structure and the cost can be reduced, which is beneficial to improving the radiation efficiency of the antenna.

The electronic device of embodiments of the present disclosure can include the above circularly polarized antenna. The circularly polarized antenna can have a simple structure to reduce the manufacturing cost, simplify the manufacturing process, and improve production efficiency. The power consumption of the antenna can be also reduced. The operation signal strength of the antenna can be improved to ensure the practicality and application reliability of the electronic device.

In some embodiments, the main board 1 and the radiator 2 are outside the shell. In some embodiments, the shell can include an annular frame. The main board 1 can be inside the shell. The radiator 2 can be connected to the frame coaxially to be beneficial to reduce the volume of the shell and realize the miniaturization of the electronic device.

The electronic device of embodiments of the present disclosure can include a smartwatch, a smart wristband, smart glasses, smart earphones, or smart clothing. For example, taking the smartwatch as an example, the electronic device can be described.

The electronic device can also include a glass dial 5. The glass dial 5 can be in the center through-hole of the radiator 2. The glass dial 5 can be fixedly connected to the radiator 2 through gluing or other methods to protect the inner structure of the electronic device and ensure the practicality and durability of the electronic device.

In some other embodiments, the glass dial 5 can also be arranged on a side of the glass dial 5 away from the main board 1.

For other structures of the electronic device, reference can be made to the related technologies.

What is claimed is:

1. A circularly polarized antenna comprising:
a main board;
a radiator in a ring shape;
a feed structure arranged between the main board and the radiator, the main board being electrically connected to the radiator through the feed structure; and
a perturbation structure arranged between the main board and the radiator and configured to disturb a resonant electromagnetic field generated by the radiator.

2. The antenna according to claim 1, wherein the perturbation structure is electrically connected to the radiator or the main board.

3. The antenna according to claim 1, wherein the perturbation structure has an arc shape, an axis of the perturbation structure is colinear with an axis of the radiator, and a central angle corresponding to the perturbation structure is smaller than 180°.

4. The antenna according to claim 3, wherein:
the perturbation structure includes two members arranged at an interval along a circumference of the radiator; and
a central angle corresponding to each of the two members is smaller than 90°.

5. The antenna according to claim 1, wherein the perturbation structure is block-shaped and is electrically connected to the main board or the radiator.

6. The antenna according to claim 5, wherein the perturbation structure is a solid structure or is hollow inside.

7. The antenna according to claim 1, wherein the perturbation structure is a concave structure and is arranged at the radiator, and an opening of the concave structure faces the main board.

8. The antenna according to claim 1, wherein:
a projection of a centerline of the perturbation structure at the radiator and a connection place of the feed structure and the radiator form an arc α in a surrounding direction, and α∈(0°, 90°)∪(180°, 270°); and
the surrounding direction is a counterclockwise surrounding direction looking from a top of the radiator.

9. The antenna according to claim 8, wherein α∈(0°, 60°)∪(180°, 240°).

10. The antenna according to claim 1, wherein:
a projection of a centerline of the perturbation structure at the radiator and a connection place of the feed structure and the radiator form an arc α in a surrounding direction, and α∈(90°, 180°)∪(270°, 360°); and
the surrounding direction is a counterclockwise surrounding direction looking from a top of the radiator.

11. The antenna according to claim 8, wherein α∈(120°, 180°)∪(300°, 360°).

12. The antenna according to claim 1, wherein:
a projection of the feed structure in a projection plane along a projection direction is outside a projection range of the perturbation structure in the projection plane along the projection direction;
the projection plane is on a side of the main board away from the radiator and parallel to the main board;
the projection direction is perpendicular to the projection plane.

13. The antenna according to claim 1, wherein a distance L between the main board and the radiator satisfies
$$L ∈ ( 0 , \frac{1}{10} M ) ,$$
M being a perimeter of the radiator.

14. The antenna according to claim 11, wherein
$$L ∈ ( 0 , \frac{1}{20} M ) .$$

15. An electronic device comprising:
a shell; and
a circularly polarized antenna including:
a main board;
a radiator in a ring shape;
a feed structure arranged between the main board and the radiator, the main board being electrically connected to the radiator through the feed structure; and
a perturbation structure arranged between the main board and the radiator and configured to disturb a resonant electromagnetic field generated by the radiator.

16. The electronic device according to claim 15, wherein the perturbation structure is electrically connected to the radiator or the main board.

17. The electronic device according to claim 15, wherein the perturbation structure has an arc shape, an axis of the perturbation structure is colinear with an axis of the radiator, and a central angle corresponding to the perturbation structure is smaller than 180°.

18. The electronic device according to claim 17, wherein:
the perturbation structure includes two members arranged at an interval along a circumference of the radiator; and
a central angle corresponding to each of the two members is smaller than 90°.

19. The electronic device according to claim 15, wherein the perturbation structure is block-shaped and is electrically connected to the main board or the radiator.

20. The electronic device according to claim 19, wherein the perturbation structure is a solid structure or is hollow inside.
